(19) United States
(12) Patent Application Publication
(10) Pub. No.: US 2026/0023997 A1
(43) Pub. Date: Jan. 22, 2026

(54) GRAPHENE BOLOMETER FOR SUPERCONDUCTING QUBIT READOUT

(71) Applicants: Raytheon BBN Technologies Corp., Cambridge, MA (US); MASSACHUSETTS INSTITUTE OF TECHNOLOGY, Cambridge, MA (US)

(72) Inventors: Kin Chung Fong, Concord, MA (US); Leonardo Matteo Ranzani, Acton, MA (US); Guilheim Jean Antoine Ribeill, Bedford, MA (US); Dirk Robert Englund, Cambridge, MA (US); Bevin Huang, Cambridge, MA (US); Ethan Arnault, Cambridge, MA (US)

(21) Appl. No.: 19/117,322

(22) PCT Filed: Aug. 4, 2023
(86) PCT No.: PCT/US2023/029573

§ 371 Date: Mar. 31, 2025

Related U.S. Application Data
(60) Provisional application No. 63/412,200, filed on Sep. 30, 2022.

(51) Int. Cl. G06N 10/40

(52) U.S. Cl. CPC G06N 10/40

(57) ABSTRACT

A system and method for measuring qubit states. In some embodiments, the system includes a first qubit and a readout circuit, the readout circuit being configured to perform a direct readout of the state of the first qubit.

### CROSS-REFERENCE TO RELATED APPLICATION

The present application is a U.S. National Application under 35 U.S.C. § 371 of International Application Number PCT/US2023/029573 filed on Aug. 4, 2023 and titled GRAPHENE BOLOMETER FOR SUPERCONDUCTING QUBIT READOUT, which claims the benefit of and priority to U.S. Provisional Application No. 63/412,200 filed on Sep. 30, 2022, both of which are incorporated herein by reference in their entireties.

### FIELD

One or more aspects of embodiments according to the present disclosure relate to qubit systems, and more particularly to a system and method for measuring qubit states.

### BACKGROUND

A quantum computer or other system including qubits may be employed for various processing functions. In such a system, it may be advantageous to measure the state of one or more of the qubits.

It is with respect to this general technical environment that aspects of the present disclosure are related.

### SUMMARY

According to an embodiment of the present disclosure, there is provided a system, including: a first qubit; and a readout circuit, the readout circuit being configured to perform a direct readout of the state of the first qubit.

In some embodiments, the readout circuit includes a microwave bolometer connected to the first qubit.

In some embodiments, the microwave bolometer includes: a first superconducting terminal; a second superconducting terminal; a third superconducting terminal; a fourth superconducting terminal; and a graphene channel including a portion of a graphene sheet, each of the first superconducting terminal and the second superconducting terminal being connected to the graphene sheet, and the third superconducting terminal, the fourth superconducting terminal, and the graphene channel together forming a Josephson junction.

In some embodiments, the Josephson junction has a kinetic inductance, the kinetic induction being a function of a temperature of the graphene channel.

In some embodiments, the first superconducting terminal is connected to the first qubit.

In some embodiments, the readout circuit is configured to infer the state of the first qubit based on an energy of a measurement pulse after interaction of the measurement pulse with the first qubit.

In some embodiments, the readout circuit is further configured to infer the energy of the measurement pulse based on a change in temperature of the graphene sheet.

In some embodiments, the readout circuit is further configured to infer the change in temperature of the graphene sheet based on a change in Josephson inductance of the Josephson junction.

In some embodiments, the readout circuit is further configured to infer the change in Josephson inductance of the Josephson junction based on a change in a reflection coefficient of a resonator including the Josephson junction.

In some embodiments, the Josephson junction includes a conductive gate, on the graphene channel.

In some embodiments, the Josephson junction further includes a gate insulating layer, between the conductive gate and the graphene channel.

In some embodiments, the system further includes a gate bias circuit connected to the conductive gate.

In some embodiments, the system further includes: a second qubit; a bus line; a first resonator, connected between the first qubit and the bus line; and a second resonator, connected between the second qubit and the bus line.

In some embodiments, the first resonator has a first resonant frequency and the second resonator has a second resonant frequency, different from the first resonant frequency.

In some embodiments, the system further includes a measurement signal source configured to drive the bus line with a measurement pulse.

In some embodiments, the measurement signal source is configured to drive the bus line with a first measurement pulse at a first point in time, and to drive the bus line with a second measurement pulse at a second point in time.

In some embodiments, the first measurement pulse has a frequency within 5% of the first resonant frequency, and the second measurement pulse has a frequency within 5% of the second resonant frequency.

In some embodiments, the first resonant frequency is between 4 gigahertz (GHz) and 8 GHz.

In some embodiments, the second resonant frequency is at least 1 megahertz greater than the first resonant frequency.

In some embodiments, the second resonant frequency is at most 100 megahertz greater than the first resonant frequency.

### BRIEF DESCRIPTION OF THE DRAWINGS

Features, aspects, and embodiments are described in conjunction with the attached drawings, in which:

FIG. 1 is a schematic drawing of a circuit for quantum computing, according to an embodiment of the present disclosure;

FIG. 2A is a schematic drawing of a portion of a bolometer, according to an embodiment of the present disclosure;

FIG. 2B is a schematic top view of a portion of a bolometer, according to an embodiment of the present disclosure;

FIG. 2C is a schematic side view of a portion of a bolometer, according to an embodiment of the present disclosure; and

FIG. 2D is a schematic side view of a graphene sandwich, according to an embodiment of the present disclosure.

### DETAILED DESCRIPTION

The detailed description set forth below in connection with the appended drawings is intended as a description of exemplary embodiments of a system and method for measuring qubit states provided in accordance with the present disclosure and is not intended to represent the only forms in which some embodiments may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

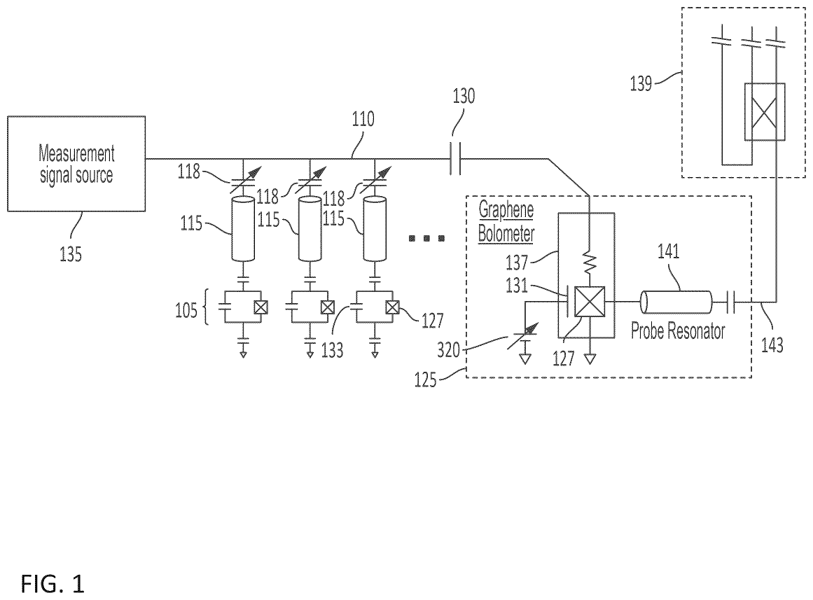

Referring to FIG. 1, in some embodiments, a circuit for quantum computing includes a plurality of qubits 105, each connected to a bus line 110 through a respective qubit resonator 115 and a respective tuning capacitor 118. The resonators may be tuned to different respective resonant frequencies. For example, each resonator may be a transmission line resonator (e.g., half-wave transmission line resonator, with a connection at each end (e.g., a series capacitor) having an impedance significantly higher than the characteristic impedance of the transmission line), and the lengths of the transmission lines may be different, or the tuning capacitors 118 may have (e.g., be adjusted to) different capacitance values.

A bolometer 125 (e.g., a graphene bolometer, as illustrated) may also be connected (e.g., via a coupling capacitor 130) to the bus line. The graphene bolometer may operate as a photon-number sensitive detector, and it may be used to detect the states of the qubits 105. For example, in operation, the state of, e.g., a first qubit 105 may be interrogated by driving the bus line (e.g., by a measurement signal source 135) with a measurement pulse containing a signal at a frequency at or near the resonant frequency of the qubit resonator 115 connected to the first qubit 105. The measurement pulse may then interact (through the qubit resonator 115) with the first qubit 105, and the energy of the measurement pulse (after interaction with the first qubit 105) that propagates, via the bus line 110, to the bolometer 125 may depend on the state of the first qubit 105. As such, measuring the energy of the pulse received by the bolometer 125 may make it possible to infer the state of the first qubit 105. The bolometer 125 may include a matching network or a capture cavity to optimize photon absorption. In some embodiments, the readout circuit further includes a processing circuit (discussed in further detail below) connected to the reflectometer 139 and configured to perform the calculation or calculations for inferring the state of the qubit 105 from the reflection coefficient or from a change in the reflection coefficient.

The measurement pulse may have a duration of a few microseconds (usee) (e.g., between 0.1 and 100.0 microseconds) and a total energy of a few photons (e.g., between 1 and 100 photons). The resonant frequencies of the qubit resonators 115 may span a frequency range extending, e.g., from 4 gigahertz (GHz) to 8 GHZ. The circuit may include one or more qubits 105, e.g., it may include a large number of qubits 105 (e.g., it may include more than 10, more than 100, or more than 1000 qubits 105), of which three exemplary qubits 105 are illustrated in FIG. 1. In some embodiments at least two of the qubit resonators 115 (e.g., all of the qubit resonators 115) may have different respective resonant frequencies, and, in some embodiments, when a measurement pulse with a frequency that is at or near the resonant frequency of one of the qubit resonators 115 is used, the measurement pulse interacts primarily with the qubit 105 connected to that qubit resonator 115 and does not interact significantly with any of the other qubits 105. The separation between adjacent frequencies (of the set of resonant frequencies of the qubit resonators 115) may be a few megahertz (MHZ), e.g., it may be between 1 MHz and 100 MHz, e.g., it may be about 10 MHz.

In some embodiments, the circuit includes a plurality of qubits 105, and the circuit is configured to measure the state of each one of the plurality of qubits 105 one at a time, using time domain multiplexing. For example, the measurement signal source 135 may emit a sequence of measurement pulses, each of the pulses having a different frequency (equal to or nearly equal to the resonant frequency of a respective one of the qubit resonators 115), and the bolometer may perform an energy measurement for each measurement pulse, to determine the state of the qubit 105 connected to the resonator having a resonant frequency equal to, or nearly equal to, the frequency of the measurement pulse. In this manner, the state of each of the qubits 105 may be periodically measured (e.g., every 100 microseconds, or every N microseconds, where N is between 100 and 1000).

The circuit may be fabricated on a silicon wafer (e.g., on a 4 inch×4 inch silicon wafer). Each of the qubits 105 may be a transmon qubit including a Josephson junction 127 connected in parallel with a shunt capacitor 133.

The bolometer 125 may also be fabricated on the silicon wafer. It may include a graphene sheet 137 connected to the input of the bolometer 125, and a Josephson junction 127 including a gate 131 (discussed in further detail below). The gate 131 may have a bias applied to it by a gate bias circuit 320. A portion of the graphene sheet 137 may be within the gap of the Josephson junction 127. The Josephson junction 127 may be connected to a probe resonator 141, which may be a length of transmission line the resonant frequency of which varies depending on the magnitude of the Josephson inductance of the Josephson junction 127.

In operation, a measurement pulse may, after interacting with one of the qubits 105, propagate on the bus line 110 and through the coupling capacitor 130, and may be absorbed by the graphene sheet 137 (e.g., by the resistance of the graphene sheet 137, illustrated by the resistor symbol in FIG. 1). The absorption of the measurement pulse may increase the temperature of the graphene sheet (e.g., it may increase the free electron temperature of the graphene sheet, which may respond, to the absorption of electromagnetic energy, more quickly and to a greater extent than the temperature of the nuclei and of the bound electrons in the graphene sheet 137).

The change in temperature of the portion of the graphene sheet 137 that is within the gap of the Josephson junction 127 may change the properties of the Josephson junction 127; for example, this change in temperature may change the Josephson inductance of the Josephson junction 127. This change in inductance may cause a change in the reflection coefficient (or S11) at the distal end 143 of the probe resonator 141. A gate 131 (discussed in further detail below) may be part of the Josephson junction 127. The bias on the gate may be used to tune the Josephson inductance of the Josephson junction 127. The change in the reflection coefficient may be measured, e.g., with a reflectometer 139. The temperature change may be inferred from the reflectometer measurement, the energy absorbed by the graphene sheet 137 may be inferred from the temperature change, and the state of the qubit 105 may be inferred from the energy absorbed by the graphene sheet 137. As such, the state of the qubit 105 may be inferred from the reflection coefficient measured by the reflectometer 139. The bolometer 125 and the reflectometer 139 may together operate as a readout circuit configured to perform a direct readout of the state of one or more of the qubits 105. As used herein, a “direct readout” of the qubit refers to a measurement of the energy of the measurement pulse after interaction with the qubit, without frequency conversion (e.g., without (i) down-converting the measurement pulse to an intermediate frequency or to baseband and (ii) measuring the amplitude of the intermediate frequency or baseband signal).

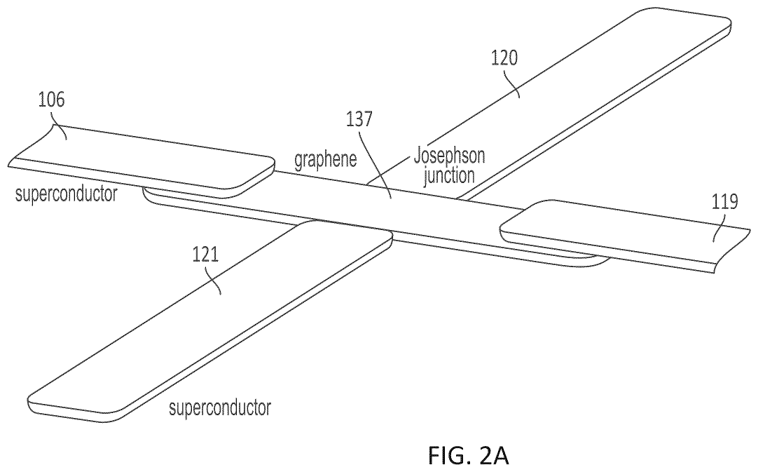

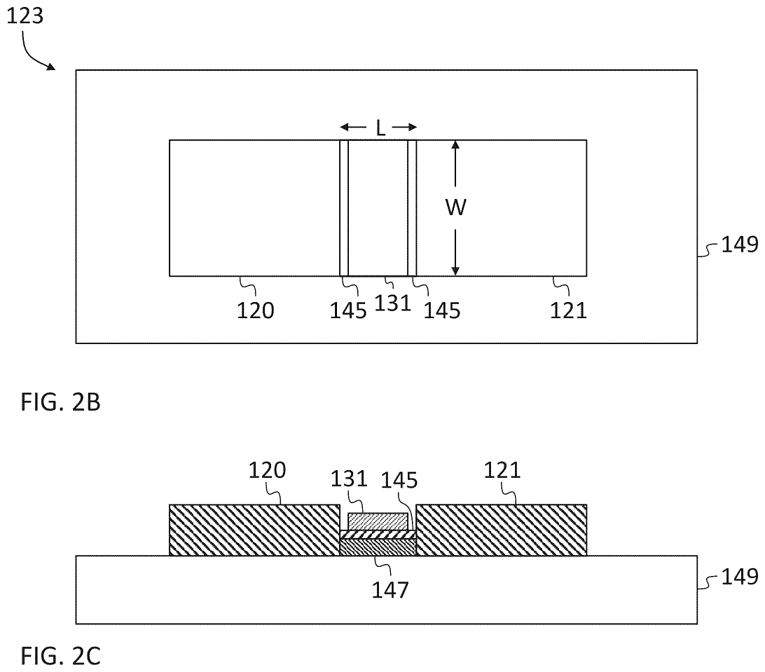

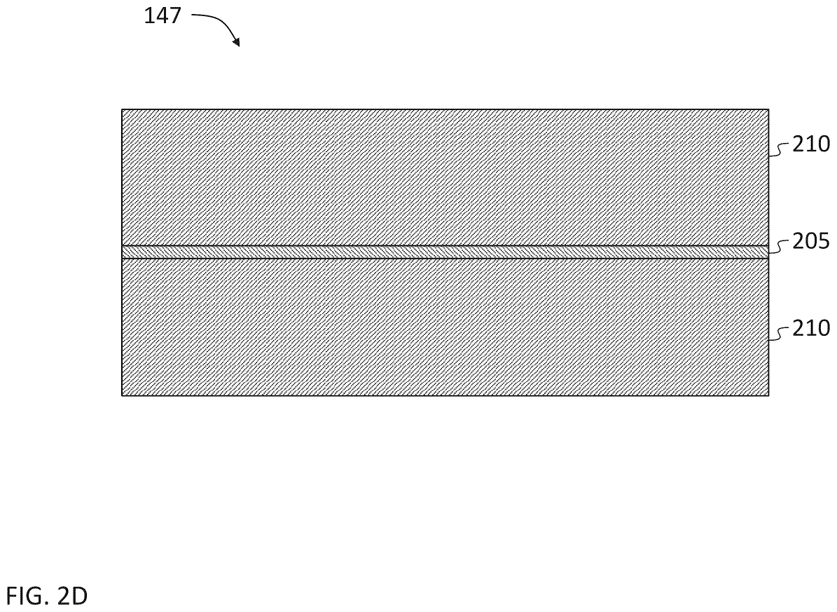

FIG. 2A shows a portion of the bolometer 125, including a first superconductor 106, a second superconductor 119, a graphene sheet 137, a third superconductor 120 and a fourth superconductor 121. The third superconductor 120 and the fourth superconductor 121 form, together with a portion of the graphene sheet 137, the Josephson junction 127. Each of the superconductors may also be referred to as a “superconducting terminal”. As illustrated, the graphene sheet 137 may extend into the gap of the Josephson junction 127, i.e., in the embodiment of FIG. 2A, into the gap between the third superconductor 120 and the fourth superconductor 121. The gate 131 is not shown in FIG. 2A, for ease of illustration.

FIGS. 2B and 2C are a schematic top view and side view of a portion of the bolometer 125, in some embodiments. The first superconductor 106, and the second superconductor 119 are not shown in FIG. 2B and FIG. 2C, for ease of illustration. The illustrated portion of the bolometer 125 includes the third superconductor 120, the fourth superconductor 121, and a conductive gate 131. As used herein, a “superconducting terminal”, or a “superconductor” is component, of the graphene-based bolometer 125, composed of a material that behaves as a superconductor under suitable conditions, e.g., at sufficiently low temperature, magnetic field, and current density. As such, the first superconductor 106, the second superconductor 119, the third superconductor 120 and the fourth superconductor 121 of the bolometer 125 of FIGS. 2A, 2B, and 2C may be referred to as superconductors, or as superconducting terminals, regardless of whether the bolometer 125 is at sufficiently low temperature for these terminals 106, 119, 120, 121 to be superconducting.

The third superconductor 120 and the fourth superconductor 121 may each be composed of any of a number of materials known in the art that become superconductive at low temperatures, including niobium nitride, niobium titanium nitride, niobium diselenide, molybdenum rhenium alloy, aluminum, niobium, niobium titanium, or lead. In some embodiments, a graphene sheet forms a graphene channel of the Josephson junction 127 of the bolometer 125. As used herein, a “graphene channel” is a graphene sheet, or a portion of a graphene sheet, that forms a conductive path between two superconducting terminals 120, 121 of a Josephson junction 127. This element may be referred to as a “channel” (and the conductive gate 131 may be referred to as a “gate”) in part because in certain respects the behavior of the graphene-based bolometer 125 may be analogous to the behavior of a field effect transistor. The conductive path may include one or more gaps, e.g., a gap between each superconducting terminal 120, 121 and the graphene sheet, across which electrons may be conducted by tunneling. The graphene sheet may be part of a graphene sandwich 147, an enlarged view of a portion of which is shown in FIG. 2D. The graphene sandwich 147 may include the graphene sheet 137, between two insulating layers 210, e.g., between two layers of hexagonal boron nitride. The graphene sheet 137 may consist of one, two, three, four, or as many as ten atomic layers of graphene. Each layer 210 of hexagonal boron nitride may be between 0.3 nm and 100 nm thick; the layers 210 of hexagonal boron nitride may keep the surface of the graphene sheet 137 clean, i.e., they may prevent surface contamination from compromising the properties of the graphene sheet 137.

Each hexagonal boron nitride layer 210 may be a single crystal, with an atomically flat surface facing the graphene sheet 137. Each hexagonal boron nitride layer 210 may be annealed, e.g., at 250° C. for 10-15 minutes, before the sandwich is assembled. The sandwich may be formed by first bringing a first layer 210 of hexagonal boron nitride into contact with the graphene sheet 137, resulting in adhesion of the graphene sheet 137 to the hexagonal boron nitride by van der Waals forces, and then bringing the graphene sheet 137, on the first layer 210 of hexagonal boron nitride, into contact with the second layer 210 of hexagonal boron nitride, resulting in adhesion, again by van der Waals forces, at the interface between the graphene sheet 137 and the second layer 210 of hexagonal boron nitride. The edges of the sandwich may then be etched, e.g., using plasma etching, so that in the structure remaining after the etch process the edges of the two layers 210 of hexagonal boron nitride and the edges of the graphene sheet 137 coincide (i.e., are aligned). In some embodiments, the graphene sheet is kept sufficiently clean during fabrication of the graphene sandwich 147, and thereafter by the protective layers 210 of hexagonal boron nitride, that the graphene sheet has an electron mobility of more than 100,000 cm²/V/s.

In some embodiments, as shown in FIGS. 2B and 2C, the first superconducting terminal 120 and the second superconducting terminal 121 make contact with respective (e.g., opposite) edges of the graphene sheet 137 by abutting against respective edges of the graphene sandwich 147 as shown, or, in other embodiments, by extending up onto the top surface of the graphene sandwich 147 (e.g., by being deposited, onto the graphene sandwich 147, as a patch extending across the edge of the graphene sandwich 147) so that respective vertical or steeply inclined portions, of the first superconducting terminal 120 and of the second superconducting terminal 121, are (i) in contact with an edge of the graphene sheet 137 or (ii) in sufficiently close proximity with the graphene sheet 137 that electrons may be conducted between the graphene sheet 137 and the third superconducting terminal 120, and between the graphene sheet 137 and the fourth superconducting terminal 121, by tunneling across respective gaps between the graphene sheet 137 and the first superconducting terminal 120, and between the graphene sheet 137 and the second superconducting terminal 121. As illustrated in FIG. 2C, in some embodiments, a gate insulating layer 145, e.g., a layer of aluminum oxide or of hafnium oxide, or an additional, separately formed, layer of hexagonal boron nitride, may be between the conductive gate 131 and the graphene sandwich 147.

The graphene-based bolometer 125 a portion of which is illustrated in FIGS. 2A and 2B is formed, in some embodiments, by placing the graphene sandwich 147 on a substrate 149, depositing the third superconducting terminal 120 and the fourth superconducting terminal 121 on the substrate 149 (and onto the graphene sandwich 147, if they overlap onto the graphene sandwich 147), depositing the gate insulating layer 145 (if it is present) on the graphene sandwich 147, and depositing the conductive gate 131 onto the gate insulating layer 145 (or, if the gate insulating layer 145 is absent, directly onto the graphene sandwich 147).

Contacts to external circuitry may be formed, for example, by forming wire bonds to the third superconducting terminal 120, to the fourth superconducting terminal 121 and to the conductive gate 131. In some embodiments, the deposition steps are performed in a different order, to similar effect.

The substrate 149 may be a silicon substrate, and it may be selected for low conductivity, to reduce interactions between the active elements of the graphene-based bolometer 125 and the substrate 149. The substrate 149 may be composed, for example, of highly resistive crystalline silicon having a low doping level, such as float zone silicon. The graphene-based bolometer 125 may be operated at a cryogenic temperature. In one embodiment, the graphene-based bolometer 125 is cooled to 4 K, using, for example, a pulse tube refrigerator or a Gifford-McMahon (GM) cooler. In other embodiments direct cooling with liquid helium, or with liquid helium in a partial vacuum (e.g., using a 1 K pot, to reach temperatures below 4 K) may be used to cool the graphene-based bolometer 125.

In operation (e.g., at a temperature of between 0.01 K and 5 K), the graphene-based bolometer 125 may behave, when the conductive gate 131 is at the same potential, or at substantially the same potential, as the third superconducting terminal 120 and as the fourth superconducting terminal 121, as a Josephson junction 127, forming a superconducting connection (with no voltage drop) between the third superconducting terminal 120 and the fourth superconducting terminal 121 when the current flowing between the third superconducting terminal 120 and the fourth superconducting terminal 121 is less than a critical current of the Josephson junction, and forming a normal connection between the third superconducting terminal 120 and the fourth superconducting terminal 121 when the current exceeds the critical current of the Josephson junction.

When the current exceeds the critical current of the Josephson junction, the normal connection between the third superconducting terminal 120 and the fourth superconducting terminal 121 may have a resistance (that may be referred to as the “normal state resistance” (Rn)), and a corresponding voltage drop may be present across the third superconducting terminal 120 and the fourth superconducting terminal 121. The DC voltage drop across the third superconducting terminal 120 and the fourth superconducting terminal 121 may be equal to the product of (i) the normal state resistance and (ii) the DC current flowing between the third superconducting terminal 120 and the fourth superconducting terminal 121.

In operation, a voltage may be applied to the conductive gate 131 of the graphene-based bolometer 125, affecting the current flowing between the third superconducting terminal 120 and the fourth superconducting terminal 121, or the DC voltage across the third superconducting terminal 120 and the fourth superconducting terminal 121, or both, depending on the external circuit connected to the third superconducting terminal 120 and the fourth superconducting terminal 121.

A change in the voltage applied to the conductive gate 131 may alter the Fermi level for electrons within the band structure of the graphene sheet, and accordingly the normal state resistance of the graphene-based bolometer 125 may vary as a function of the voltage across the conductive gate 131 and the graphene channel. Similarly, the Josephson inductance of the Josephson junction 127 may vary as a function of the voltage across the conductive gate 131 and the graphene channel. As such, the Josephson inductance of the Josephson junction 127 of the graphene-based bolometer 125 may be tuned by adjusting the gate voltage. In some embodiments, the gate voltage may be adjusted over a range extending from −50 V to 50 V. As used herein, the “potential of the graphene channel” is defined to be the average of (i) the potential of the third superconducting terminal 120 at the junction between the third superconducting terminal 120 and the graphene sheet 137, and (ii) the potential of the fourth superconducting terminal 121 at the junction between the fourth superconducting terminal 121 and the graphene sheet 137. As used herein, the “voltage across the conductive gate 131 and the graphene channel” is defined to be the difference between the potential of the conductive gate 131 and the potential of the graphene channel.

In some embodiments, the distance L between the superconductors (FIG. 2B) (or the “channel length” of the Josephson junction 127 or the length of the “gap” between the third superconducting terminal 120 and the fourth superconducting terminal 121) is about 200 nm (e.g., it is between 100 nm and 1000 nm) and the channel width W (or the width of the gap between the third superconducting terminal 120 and the fourth superconducting terminal 121) is about 1.5 microns (e.g., it is between 0.5 microns and 10 microns).

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X−Y and the second quantity is at most X+Y. As used herein, when a second number is “within Y %” of a first number, it means that the second number is at least (1−Y/100) times the first number and the second number is at most (1+Y/100) times the first number. As used herein, the word “or” is inclusive, so that, for example, “A or B” means any one of (i) A, (ii) B, and (iii) A and B.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the term “major component” refers to a component that is present in a composition, polymer, or product in an amount greater than an amount of any other single component in the composition or product. In contrast, the term “primary component” refers to a component that makes up at least 50% by weight or more of the composition, polymer, or product. As used herein, the term “major portion”, when applied to a plurality of items, means at least half of the items. As used herein, any structure or layer that is described as being “made of” or “composed of” a substance should be understood (i) in some embodiments, to contain that substance as the primary component or (ii) in some embodiments, to contain that substance as the major component.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

It will be understood that when an element is referred to as being “directly connected” or “directly coupled” to another element, there are no intervening elements present. As used herein, “generally connected” means connected by an electrical path that may contain arbitrary intervening elements, including intervening elements the presence of which qualitatively changes the behavior of the circuit. As used herein, “connected” means (i) “directly connected” or (ii) connected with intervening elements, the intervening elements being ones (e.g., low-value resistors or inductors, or short sections of transmission line) that do not qualitatively affect the behavior of the circuit.

Although limited embodiments of a system and method for measuring qubit states have been specifically described and illustrated herein, many modifications and variations will be apparent to those skilled in the art. Accordingly, it is to be understood that a system and method for measuring qubit states employed according to principles of this disclosure may be embodied other than as specifically described herein. Features of some embodiments are also defined in the following claims, and equivalents thereof.

What is claimed:

1. A system, comprising:
a first qubit coupled to a first qubit resonator;
a bus line coupled with the first qubit resonator; and
a readout circuit, wherein the readout circuit includes a microwave bolometer comprising:
a graphene sheet connected between a first superconducting terminal and a second superconducting terminal, wherein the first superconducting terminal is connected to the bus line; and
a third superconducting terminal and a fourth superconducting terminal arranged around the graphene sheet to form a Josephson junction, wherein the readout circuit is configured to perform a direct readout of a state of the first qubit based on one or more properties of the Josephson junction in response to a measurement pulse resonant with the first qubit resonator from the bus line.

2. (canceled)

3. The system of claim 1, wherein the one or more properties of the Josephson junction are associated with a temperature of the graphene sheet, wherein the temperature of the graphene sheet changes in response to absorption of energy of the measurement pulse, wherein the energy of the measurement pulse resonant with the first qubit resonator is associated with the state of the first qubit.

4. The system of claim 3, wherein the Josephson junction has a kinetic inductance, the kinetic inductance being a function of the temperature of the graphene sheet.

5-7. (canceled)

8. The system of claim 3, wherein the readout circuit is further configured to infer a change in temperature of the graphene sheet based on a change in Josephson inductance of the Josephson junction.

9. The system of claim 8, wherein the readout circuit is further configured to infer the change in the Josephson inductance of the Josephson junction based on a change in a reflection coefficient of a resonator including the Josephson Junction, wherein the resonator is coupled to at least one of the third superconducting terminal or the fourth superconducting terminal.

10. The system of claim 9, wherein the Josephson junction comprises a conductive gate coupled to the graphene sheet.

11. The system of claim 10, wherein the Josephson junction further comprises a gate insulating layer, between the conductive gate and the graphene sheet.

12. The system of claim 10, further comprising a gate bias circuit connected to the conductive gate, wherein the gate bias circuit tunes the Josephson inductance of the Josephson junction.

13. The system of claim 1, further comprising: a second qubit coupled to a second qubit resonator, wherein the bus line is further coupled with the second qubit resonator.

14. The system of claim 13, wherein the first qubit resonator has a first resonant frequency and the second qubit resonator has a second resonant frequency different from the first resonant frequency.

15. The system of claim 14, further comprising a measurement signal source configured to drive the bus line with the measurement pulse.

16. The system of claim 15, wherein the measurement signal source is configured to drive the bus line with a first measurement pulse at a first point in time, and to drive the bus line with a second measurement pulse at a second point in time.

17. The system of claim 16, wherein the first measurement pulse has a frequency within 5% of the first resonant frequency, and the second measurement pulse has a frequency within 5% of the second resonant frequency.

18. The system of claim 14, wherein the first resonant frequency is between 4 gigahertz (GHz) and 8 GHz.

19. The system of claim 14, wherein the second resonant frequency is at least 1 megahertz greater than the first resonant frequency.

20. The system of claim 14, wherein the second resonant frequency is at most 100 megahertz greater than the first resonant frequency.

21. The system of claim 9, further comprising a reflectometer to measure the change in the reflection coefficient of the resonator including the Josephson junction.

22. The system of claim 9, wherein the first superconducting terminal and the second superconducting terminal are separated along a first direction of the graphene sheet, wherein the third superconducting terminal and the fourth superconducting terminal are separated along a second direction of the graphene sheet different than the first direction.

23. The system of claim 1, wherein the first qubit, the first qubit resonator, and at least a portion of the readout circuit are formed on a common wafer.

24. The system of claim 1, further comprising a capacitor on the bus line between the first qubit resonator and the first superconducting terminal.
